(19) United States
(12) Patent Application Publication
(10) Pub. No.: US 2023/0300687 A1
(43) Pub. Date: Sep. 21, 2023

(54) Predictive Roaming and Resource Allocation Based on Historical Behavior

(71) Applicant: ARRIS Enterprises LLC, Suwanee, GA (US)

(72) Inventors: Ravi Kiran Mattaparti, Cupertino, CA (US); Hemant Bhatnagar, Cupertino, CA (US); Viney Kumar, Fremont, CA (US); Virendra Malaviya, Cupertino, CA (US)

(73) Assignee: ARRIS Enterprises LLC, Suwanee, GA (US)

(21) Appl. No.: 18/122,171

(22) Filed: Mar. 16, 2023

Related U.S. Application Data
(60) Provisional application No. 63/321,267, filed on Mar. 18, 2022.

(51) Int. Cl. H04W 36/00; H04W 12/0471; H04W 72/51; H04W 36/32

(52) U.S. Cl. CPC H04W 36/0038; H04W 12/0471; H04W 72/51; H04W 36/32

(57) ABSTRACT

During operation, a computer system may receive, associated with an access point, connection information, where the connection information indicates that an electronic device is currently associated with the access point in a wireless network. Then, the computer system may access information specifying historical behavior of the electronic device in the wireless network. Moreover, based at least in part on the historical behavior of the electronic device, the computer system may predict future roaming of the electronic device in the wireless network, where the predicted future roaming includes a prediction that the electronic device will establish a connection with a neighbor access point in the wireless network. Next, the computer system may provide, addressed to the neighbor access point, at least a portion of an encryption key(s) associated with a current connection between the access point and the electronic device.

### CROSS REFERENCE TO RELATED APPLICATIONS

This application claims priority under 35 U.S.C. 119(e) to U.S. Provisional Application Ser. No. 63/321,267, “Predictive Roaming and Resource Allocation Based on Historical Behavior,” filed on Mar. 18, 2022, by Ravi Kiran Mattaparti, et al. the contents of which are herein incorporated by reference.

### FIELD

The described embodiments relate to techniques for distributing encryption keys in a wireless network to support predictive client roaming based at least in part on historical behavior of an electronic device in the wireless network.

### BACKGROUND

Many electronic devices are capable of wirelessly communicating with other electronic devices. Notably, these electronic devices can include a networking subsystem that implements a network interface for: a cellular network (UMTS, LTE, 5G Core or 5GC, etc.), a wireless local area network (e.g., a wireless network such as described in the Institute of Electrical and Electronics Engineers (IEEE) 802.11 standard or Bluetooth™ from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

In a wireless network with multiple access points, an electronic device may establish connections with different access points as it moves to different geographic locations. For example, as a user walks through a building with the electronic device, the signal strength of wireless signals from an access point that the electronic device is currently associated with may decrease, while the signal strength of wireless signals from a second or neighbor access point may increase. Consequently, the electronic device may perform a basic service set (BSS) transition of a connection from the access point to the second or neighbor access point. Notably, the electronic device may de-associate from the current access point, and may reassociate and establish a connection with the second or neighbor access point. This process is sometimes referred to as ‘roaming.’

Because the communication channel in a WLAN is, in principle, shared with multiple electronic devices, communications in the WLAN may not be secure. Consequently, the electronic device and the access point may establish secure communication by exchanging encryption keys during association. Then, the communication between the electronic device and the access point may be secure.

When the electronic device performs the BSS transition, there is typically a need to establish the secure communication with the second or neighbor access point. However, because multiple messages may be exchanged between the electronic device and the second or neighbor access point while establishing a secure (encrypted) connection with the second or neighbor access point (e.g., when authentication is performed according to IEEE 802.1X in addition to encryption key negotiation according to IEEE 802.11i), the time needed to establish the secure connection may be significant. For example, the delay may be several seconds. If this exceeds the maximum value of 50 ms that is allowed for voice traffic (such as Voice over Internet Protocol or VoIP) and will result in interrupted service because of lost or delayed packets. Moreover, these problems are increased when the electronic device is used in an automotive environment, because a BSS transition may occur every 5-10 s.

In principle, these problems are addressed by IEEE 802.11r. Notably, IEEE 802.11r specifies fast BSS transitions between access points by allowing the negotiation messages and requests for wireless resources to occur in parallel. Furthermore, in order to accelerate the encryption key negotiation according to IEEE 802.11i with authentication according to IEEE 802.1X, a portion of the encryption key may be cached in the wireless network (which is sometimes referred to as ‘opportunistic key caching’ or OKC), so that a number of future connections can use the cached key, thereby avoiding the IEEE802.1X process and significantly reducing the time needed to establish a new secure connection with the second or neighbor access point.

However, in practice, security vulnerabilities have been identified with OKC and the fast BSS transitions in IEEE 802.11r. Notably, security researchers have identified encryption key installation attaches and techniques for cracking the encryption keys in wireless networks that use IEEE 802.11r.

### SUMMARY

In a first group of embodiments, a computer system that predicts future roaming is described. This computer system may include an interface circuit that communicates with an access point and a neighbor access point. During operation, the computer system receives, associated with the access point, connection information, where the connection information indicates that an electronic device is currently associated with the access point in a wireless network. Then, the computer system accesses information specifying historical behavior of the electronic device in the wireless network. Moreover, based at least in part on the historical behavior of the electronic device, the computer system predicts the future roaming of the electronic device in the wireless network, where the predicted future roaming includes a prediction that the electronic device will establish a connection with the neighbor access point in the wireless network. Next, the computer system provides, addressed to the neighbor access point, at least a portion of an encryption key associated with a current connection between the access point and the electronic device, where at least the portion of the encryption key facilitates a fast BSS or Extended Service Set (ESS) transition and secure communication with the electronic device when the predicted future roaming occurs.

Note that the predicted future roaming may include a predicted geographic path of the electronic device, and the neighbor access point may be proximate to the predicted geographic path or may be within wireless range of the predicted geographic path. Consequently, the predicted future roaming may be based at least in part on a geographic location of the neighbor access point.

Moreover, the computer system may include a controller of the access point and the neighbor access point. Alternatively, the computer system may include a cloud-based computer system that communicates with the access point and the neighbor access point using wired communication.

Furthermore, the historical behavior may include previous geographic locations of the electronic device as a function of timestamp. Alternatively, or additionally, the historical behavior may include previous instances of roaming by the electronic device in the wireless network. In some embodiments, the historical behavior may include previous throughput or utilization by the electronic device, and the predicted future roaming may be based at least in part on current communication performances of the access point and the neighbor access point.

Another embodiment provides a computer-readable storage medium with program instructions for use with the computer system, the access point or the neighbor access point. When executed by the computer system, the access point or the neighbor access point, the program instructions cause the computer system, the access point or the neighbor access point to perform at least some of the aforementioned operations or counterparts to at least some of the aforementioned operations in one or more of the preceding embodiments.

Another embodiment provides a method, which may be performed by the computer system, the access point or the neighbor access point. This method includes at least some of the aforementioned operations or counterparts to at least some of the aforementioned operations in one or more of the preceding embodiments.

In a second group of embodiments, a computer system that predicts use of wireless resources is described. This computer system may include an interface circuit that communicates with an access point. During operation, the computer system receives, associated with the access point, information that specifies a request for wireless resources associated with an application executing on an electronic device, where the electronic device is currently associated with the access point. Then, the computer system accesses second information specifying historical usage of wireless resources associated with the application. Moreover, based at least in part on the historical usage of the wireless resources, the computer system predicts the use of the wireless resources associated with the application executing on the electronic device. Next, the computer system provides, addressed to the access point, instructions for second wireless resources to provide to the electronic device, where the second wireless resources are based at least in part on the predicted use of the wireless resources, and where the second wireless resources are at least partially different from the wireless resources.

Note that the computer system may include a controller of the access point. Alternatively, the computer system may include a cloud-based computer system that communicates with the access point using wired communication.

Another embodiment provides a computer-readable storage medium with program instructions for use with the computer system or the access point. When executed by the computer system or the access point, the program instructions cause the computer system or the access point to perform at least some of the aforementioned operations or counterparts to at least some of the aforementioned operations in one or more of the preceding embodiments.

Another embodiment provides a method, which may be performed by the computer system or the access point. This method includes at least some of the aforementioned operations or counterparts to at least some of the aforementioned operations in one or more of the preceding embodiments.

This Summary is provided for purposes of illustrating some exemplary embodiments to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for predicting future roaming using a computer system in FIG. 1 in accordance with an embodiment of the present disclosure.

FIG. 3 is a drawing illustrating an example of communication between a computer system, an access points and a neighbor access point in FIG. 1 in accordance with an embodiment of the present disclosure.

FIG. 4 is a drawing illustrating an example of predicted future roaming in accordance with an embodiment of the present disclosure.

FIG. 5 is a flow diagram illustrating an example of a method for predicting use of wireless resources using a computer system in FIG. 1 in accordance with an embodiment of the present disclosure.

FIG. 6 is a drawing illustrating an example of communication between a computer system and an access point in FIG. 1 in accordance with an embodiment of the present disclosure.

FIG. 7 is a drawing illustrating an example of predicted airtime allocation in accordance with an embodiment of the present disclosure.

FIG. 8 is a drawing illustrating an example of predicted use of wireless resources in accordance with an embodiment of the present disclosure.

FIG. 9 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer system (which may include one or more computers) that predicts future roaming is described. During operation, the computer system may receive, associated with an access point, connection information, where the connection information indicates that an electronic device is currently associated with the access point in a wireless network. Then, the computer system may access information specifying historical behavior of the electronic device in the wireless network. Moreover, based at least in part on the historical behavior of the electronic device, the computer system may predict the future roaming of the electronic device in the wireless network, where the predicted future roaming includes a prediction that the electronic device will establish a connection with a neighbor access point in the wireless network. Next, the computer system may provide, addressed to the neighbor access point, at least a portion of an encryption key associated with a current connection between the access point and the electronic device, where at least the portion of the encryption key facilitates a fast BSS or a fast ESS transition and secure communication with the electronic device when the predicted future roaming occurs.

By providing at least the encryption key(s), these communication techniques may facilitate a rapid or fast BSS or ESS transition from the access point to the neighbor access point during roaming. In addition, the communication techniques may facilitate rapid establishment (e.g., in less than 50 ms) of secure communication between the electronic device and the neighbor access point during the roaming. For example, a secure connection between the electronic device and the neighbor access point may be established without interrupting traffic (such as voice traffic or Vol P) associated with the electronic device. Moreover, the communication techniques may avoid security problems associated with OKC and/or IEEE 802.11r. Consequently, the communication techniques may improve the user experience when using the electronic device, the access point and/or the neighbor access point.

In a second group of embodiments, a computer system (which may include one or more computers) that predicts use of wireless resources is described. During operation, the computer system may receive, associated with an access point, information that specifies a request for wireless resources associated with an application executing on an electronic device, where the electronic device is currently associated with the access point. Then, the computer system may access second information specifying historical usage of wireless resources associated with the application. Moreover, based at least in part on the historical usage of the wireless resources, the computer system may predict the use of the wireless resources associated with the application executing on the electronic device. Next, the computer system may provide, addressed to the access point, instructions for second wireless resources to provide to the electronic device, where the second wireless resources are based at least in part on the predicted use of the wireless resources, and where the second wireless resources are at least partially different from the wireless resources.

By providing the instructions, these communication techniques may eliminate a need for the electronic device to ask or request a change or additional wireless resources. Moreover, because the second wireless resources may be a better match to the needs of the application, the communication performance of the electronic device and the performance of the application may be improved. Consequently, the communication techniques may improve the user experience when using the electronic device and/or the access point.

In the discussion that follows, electronic devices or components in a system communicate packets in accordance with a wireless communication protocol, such as: a wireless communication protocol that is compatible with an IEEE 802.11 standard (which is sometimes referred to as from the Wi-Fi Alliance of Austin, Texas), Bluetooth or Bluetooth low energy (BLE), an IEEE 802.15.4 standard (which is sometimes referred to as Zigbee), a cellular-telephone network or data network communication protocol (such as a third generation or 3G communication protocol, a fourth generation or 4G communication protocol, e.g., Long Term Evolution or LTE or 5GC (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11 ax, IEEE 802.11ba, IEEE 802.11be, or other present or future developed IEEE 802.11 technologies. Moreover, an access point, a radio node, a base station or a switch in the wireless network and/or the cellular-telephone network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

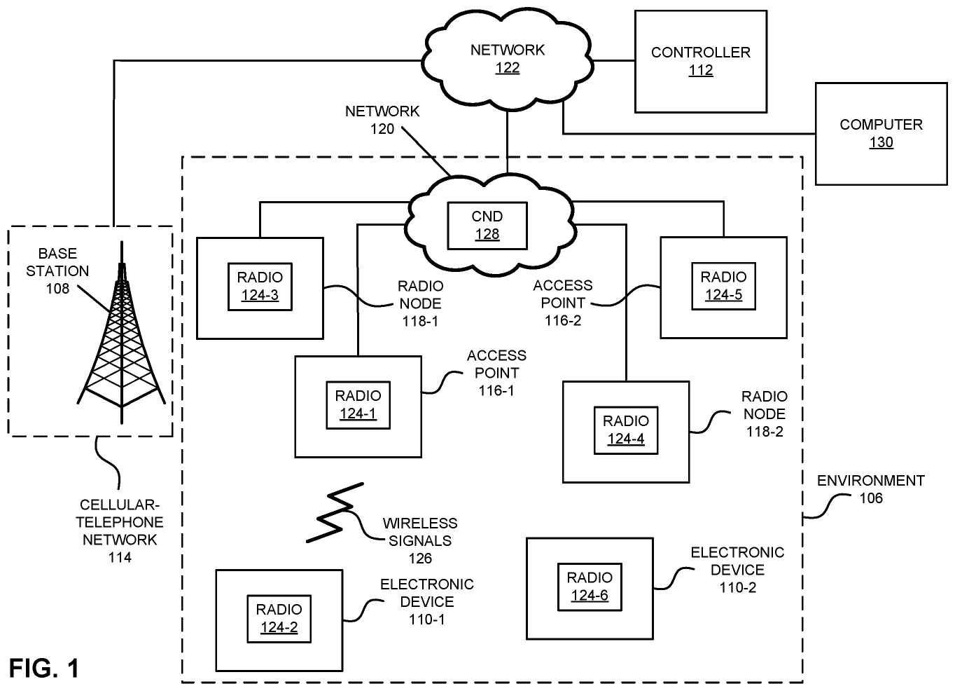

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a macrocell in a cellular-telephone network 114 (which may include a base station 108), one or more access points 116 (which may communicate using Wi-Fi) in a WLAN and/or one or more radio nodes 118 (which may communicate using LTE) in another cellular-telephone network (such as a small-scale network or a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘computer network device.’ Moreover, one or more base stations (such as base station 108), access points 116, and/or radio nodes 118 may be included in one or more wireless networks, such as: a WLAN and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or controller 112 (which may be a local or a cloud-based controller that manages and/or configures access points 116, radio nodes 118 and/or a computer network device (CND) 128, or that provides cloud-based storage and/or analytical services) using a wired communication protocol (such as Ethernet) via network 120 and/or 122. Alternatively, or additionally, access points 116 and/or radio nodes 118 may communicate with computer system 130 using the wired communication protocol. However, in some embodiments, access points 116 and/or radio nodes 118 may communicate with each other, controller 112 and/or computer system 130 using wireless communication (e.g., one of access points 116 may be a mesh access point in a mesh network). Note that networks 120 and 122 may be the same or different networks. For example, networks 120 and/or 122 may an LAN, an intra-net or the Internet. In some embodiments, network 120 may include one or more routers and/or switches (such as computer network device 128).

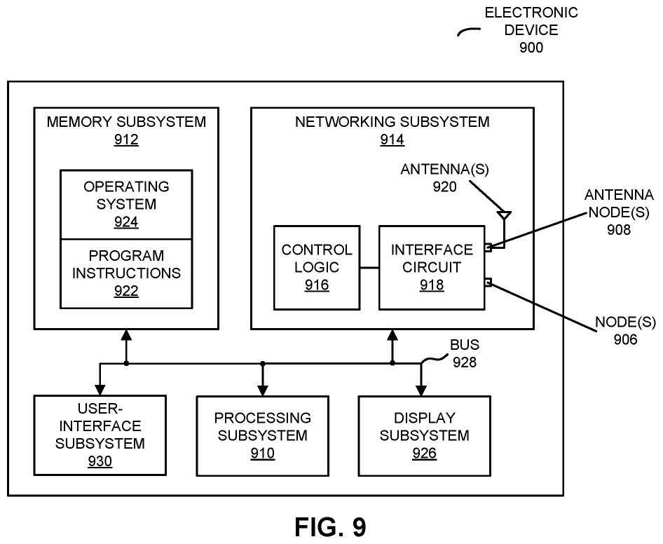

As described further below with reference to FIG. 9, electronic devices 110, controller 112, access points 116, radio nodes 118, computer network device 128, and/or computer system 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as, but not limited to: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

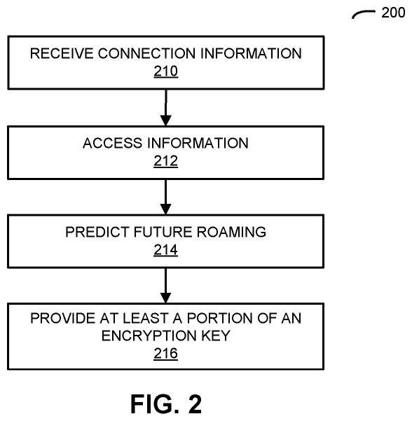

As discussed previously, it can be difficult to rapidly perform a BSS or an ESS transition and to establish a second connection during roaming. Moreover, as discussed in FIGS. 2-6, in order to address these problems computer system 130 may predict future roaming. Notably, computer system 130 may receive, from an access point (such as access point 116-1), connection information, where the connection information indicates that an electronic device (such as electronic device 110-1) is currently associated with access point 116-1 in a wireless network. Then, computer system 130 may access information (e.g., in memory associated with computer system 130) specifying historical behavior of electronic device 110-1 in the wireless network.

Furthermore, based at least in part on the historical behavior of electronic device 110-1, computer system 130 may predict the future roaming of electronic device 110-1 in the wireless network, where the predicted future roaming includes a prediction that electronic device 110-1 will establish a connection with a neighbor access point (such as access point 116-2) in the wireless network. Note that the predicted future roaming may include a predicted geographic path of electronic device 110-1, and access point 116-2 may be proximate to the predicted geographic path or may be within wireless range of the predicted geographic path. Consequently, the predicted future roaming may be based at least in part on a geographic location of access point 116-1 and/or access point 116-2.

Next, computer system 130 may provide, addressed to access point 116-2, at least a portion of an encryption key (such as a pairwise master key or OKC) associated with a current connection between access point 116-1 and electronic device 110-1. Note that at least the portion of the encryption key facilitates a fast BSS or a fast ESS transition and secure communication with electronic device 110-1 when the predicted future roaming occurs (such as access point 116-2 and electronic device 110-1 establishing a secure connection within less than 50 ms).

Additionally, the historical behavior may include previous geographic locations of electronic device 110-1 as a function of timestamp (such as day of the week, date, time, week, month, season, etc.). Alternatively, or additionally, the historical behavior may include previous instances of roaming by electronic device 110-1 in the wireless network (such as a previous BSS or ESS transition to access point 116-2). In some embodiments, the historical behavior may include previous throughput or utilization by electronic device 110-1, and the predicted future roaming may be based at least in part on current communication performances of access point 116-1 and/or access point 116-2. Thus, if the communication performance of access point 116-2 (e.g., utilization or loading) is better than the communication performance of access point 116-1, and electronic device 110-1 is predicted to need more communication performance (such as an increased throughput) and to be within wireless range of access point 116-2 in the future, then the predicted future roaming may include a predicted BSS or ESS transition to access point 116-2. In general, the predicted future roaming may be based at least in part on a spatial and/or a temporal historical pattern of behavior of electronic device 110-1 in the wireless network or another similar wireless network (when historical behavior data is available for such a similar wireless network). For example, the similar wireless network may include a different subnet than the wireless network or the similar wireless network may have one or more characteristics in common with the wireless network.

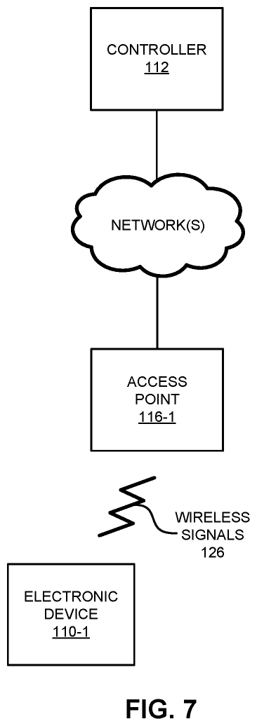

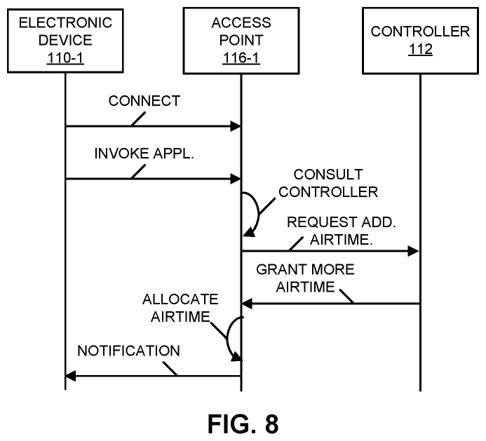

More generally, the communication techniques may be used to predict use of wireless resources. Notably, as discussed in FIGS. 7 and 8, computer system 130 may receive, associated with an access point (such as access point 116-1), information that specifies a request for wireless resources associated with an application executing on an electronic device (such as electronic device 110-1), where electronic device 110-1 is currently associated with access point 116-1. Then, computer system 130 may access second information (e.g., in memory associated with computer system 130) specifying historical usage of wireless resources associated with the application. Moreover, based at least in part on the historical usage of the wireless resources, computer system 130 may predict the use of the wireless resources associated with the application executing on electronic device 110-1. Next, computer system 130 may provide, addressed to access point 116-1, instructions for second wireless resources (such as airtime, bandwidth, data rate, capacity, utilization, one or more transmit opportunities, etc.) to provide to electronic device 110-1, where the second wireless resources are based at least in part on the predicted use of the wireless resources, and where the second wireless resources are at least partially different from the prevailing wireless resources. For example, while electronic device 110-1 may initially request 1 MB/s, using the communication techniques computer system 130 may instruct access point 116-1 to provide 3 MB/s to electronic device 110-1.

Note that at least some fairness of channel access or airtime may be maintained in the communication techniques. However, the channel access or airtime may be modified in the communication techniques from a technique where each one of electronic devices 110 has equal access and access is determined based at least in part on queue depth or a number of packets (such as several packets) pending in a queue.

In these ways, the communication techniques may predict future needs of electronic device 110-1, such as future roaming and/or future use of wireless resources. Then, computer system 130 may share at least the portion of the encryption key(s) and/or may allocate wireless resources based at least in part on the prediction(s). These capabilities may allow the wireless network to provide improved service to electronic device 110-1. For example, the wireless network may allow electronic device 110-1 to perform rapid or fast BSS or ESS transitions without interrupted service. Moreover, the wireless network may provide improved communication performance when communicating with electronic device 110-1, which may provide improved performance of an application executing on electronic device 110-1 or in an environment of electronic device 110-1 (such as in an operating system or a Web browser on electronic device 110-1). These actions may occur without waiting for electronic device 110-1 to perform the predicted future roaming or to request additional wireless resources. Thus, at least the portion of the encryption key may be intelligently pre-provisioned and/or the wireless resources may be intelligently pre-allocated to electronic device 110-1. Consequently, the communication techniques may improve the user experience when using electronic device 110-1 and/or the wireless network.

In some embodiments, the predictions of computer system 130 may be provided by a pretrained predictive model. For example, the pretrained predictive model may trained using a training dataset and a machine-learning technique, such as a supervised-learning technique and/or an unsupervised-learning technique (such as a clustering technique).

Note that the pretrained predictive model may include a classifier or a regression model that was trained using: a support vector machine technique, a classification and regression tree technique, logistic regression, LASSO, linear regression, a neural network technique (such as a convolutional neural network technique, an autoencoder neural network technique or another type of neural network technique) and/or another linear or nonlinear supervised-learning technique. The pretrained predictive model may use historical data as inputs and may output a prediction.

Moreover, while FIG. 1 illustrates cloud-based computer system 130, in other embodiments components in the communication techniques may be implemented locally and/or remotely from a property or a location where a wireless network and/for a cellular-telephone network provide coverage or service. For example, in some embodiments, at least some of the operations performed by computer system 130 may be performed by one or more of access points 116. Furthermore, the communication techniques may be implemented in a centralized and/or a distributed manner. Thus, instead of computer system 130, in other embodiments a computer system with multiple computers at one or more locations may be used.

Furthermore, while FIG. 1 illustrates controller 112 and computer system 130 as separate components, in other embodiments these components may be combined into a single component. Thus, in some embodiments, computer system 130 may be a controller.

We now describe embodiments of the method. FIG. 2 presents a flow diagram illustrating an example of a method 200 for predicting roaming, which may be performed by a computer system (such as computer system 130 in FIG. 1). During operation, the computer system may receive, associated with an access point, connection information (operation 210), where the connection information indicates that an electronic device is currently associated with the access point in a wireless network. Then, the computer system may access information (operation 212) specifying historical behavior of the electronic device in the wireless network.

Moreover, based at least in part on the historical behavior of the electronic device, the computer system may predict the future roaming (operation 214) of the electronic device in the wireless network, where the predicted future roaming includes a prediction that the electronic device will establish a connection with a neighbor access point in the wireless network. Note that the predicted future roaming may include a predicted geographic path of the electronic device, and the neighbor access point may be proximate to the predicted geographic path or may be within wireless range of the predicted geographic path. Consequently, the predicted future roaming may be based at least in part on a geographic location of the access point and/or the neighbor access point.

Next, the computer system may provide, addressed to the neighbor access point, at least a portion of an encryption key (operation 216) associated with a current connection between the access point and the electronic device, where at least the portion of the encryption key facilitates a fast BSS or a fast ESS transition and secure communication with the electronic device when the predicted future roaming occurs. For example, the computer system may provide encryption keys and/or related data to one or more neighbor access points for efficient roaming.

Moreover, the computer system may include a controller of the access point and the neighbor access point. Alternatively, the computer system may include a cloud-based computer system that communicates with the access point and the neighbor access point using wired communication.

Furthermore, the historical behavior may include previous geographic locations of the electronic device as a function of timestamp. Alternatively, or additionally, the historical behavior may include previous instances of roaming by the electronic device in the wireless network. In some embodiments, the historical behavior may include previous throughput or utilization by the electronic device, and the predicted future roaming may be based at least in part on current communication performances of the access point and/or the neighbor access point.

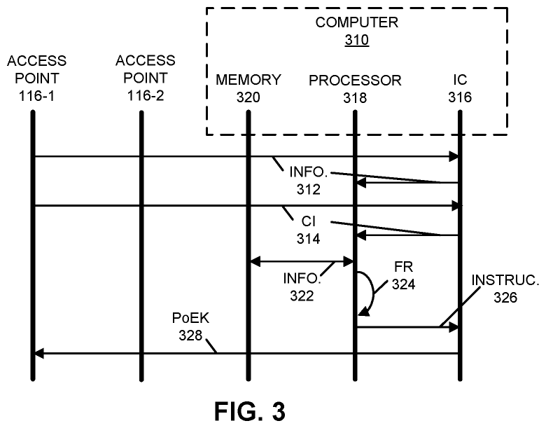

Embodiments of the communication techniques are further illustrated in FIG. 3, which presents a drawing illustrating an example of communication between access point 116-1, access point 116-2 and a computer 310 in computer system 130 (FIG. 1). In FIG. 3, access point 116-1 may optionally provide information 312 specifying an encryption key (or encryption keys) that is used to encrypt communication with the electronic device. Moreover, access point 116-1 may provide connection information (CI) 314 addressed to computer 310, where the connection information 314 indicates that an electronic device is currently associated with access point 116-1 in a wireless network.

After receiving either or both of information 312 and the connection information 314, an interface circuit (IC) 316 in computer 310 may provide information 312 and the connection information 314 to processor 318. Then, processor 318 may access, in memory 320 in or associated with computer 310, information 322 specifying historical behavior of the electronic device in the wireless network. Moreover, based at least in part on the historical behavior of the electronic device, processor 318 may predict future roaming (FR) 324 of the electronic device in the wireless network, where the predicted future roaming 324 includes a prediction that the electronic device will establish a connection with access point 116-2 in the wireless network.

Next, processor 318 may instruct 326 interface circuit 316 to provide, addressed to access point 116-1, at least a portion of an encryption key (PoEK) 328 (or information specifying at least the portion of the encryption key 328). Note that at least the portion of the encryption key 328 may facilitate a fast BSS or a fast ESS transition and secure communication with the electronic device when the predicted future roaming 324 occurs. More generally, processor 318 may instruct interface circuit 316 to provide, addressed to access point 116-1, a set of encryption keys that are needed for smooth roaming, and each of these encryption keys may facilitate a fast BSS or a fast ESS transition and secure communication with the electronic device when the predicted future roaming 324 occurs.

We now further describe the communication techniques. Many existing Wi-Fi deployments have short comings that are often addressed using cloud-based analytics. For example, a client may connect to the wrong access point (such as an access point with weak wireless signal strength), which may result in a reduced throughput.

Although protocols such as IEEE 802.11k and IEEE 802.11v have been introduced to help a wireless client to roam, the wireless client makes the roaming decision to go to another access point. Currently, an access point does not make an independent decision to roam the client.

Moreover, the current airtime allocation technique used by an access point usually does not consider the type of applications (such as work-related, entertainment, social media, etc.) that wireless clients use or execute. Consequently, when allocating airtime, the access point does not consider the throughput of the channel when the network is used heavily and the number of clients at such busy hours.

The following example illustrate clients that experience poor wireless service. Notably, in an education market segment, a client may roam between different access points and may sometime choose the wrong access point (such as an access point with sub-optimal communication performance) and the client may experience poorer service, lost connections, etc. Alternatively, or additionally, a client may choose to roam to an incorrect access point (such as an access point with sub-optimal communication performance), which may also result in poorer service, lost connection, etc. Moreover, some applications may consume more bandwidth than other applications. Consequently, providing the correct airtime utilization based at least in part on the needs of an application may result in an improved client experience. Otherwise, the use of some applications may result in a poor user experience. Furthermore, sometimes a client in a 2.4 GHz band of frequencies may have reduced throughput even though an access point is configured on a non-overlapping channel. For example, there may be multiple electronic devices operating on Bluetooth, which may saturate the 2.4 GHz band of frequencies. As described further below, in this scenario, the disclosed communication techniques may be used to instruct an access point to steer clients to the 5.0 GHz band of frequencies.

Additionally, in multi-dwelling units (MDUs), clients connected to the 2.4 GHz band of frequencies may have reduced bandwidth compared to clients that can use a higher band of frequencies (such as 5.0 or 6.0 GHz). For example, certain consumer-electronic applications or Internet-of-things (IoT) applications may use a lower band of frequencies, and data loss may need to be minimal or there may need to be no loss. Alternatively, other applications may have high priority (such as video conferencing).

In the disclosed communication techniques, a cloud-based computer may aggregate information about active connections and/or airtime allocation for different applications. Alternatively, or additionally, roaming may be assisted by the cloud-based computer using heuristic data.

In many scenarios, note that clients may roam when an access point is in an idle condition (such as a long sleep mode, so that a client may think the access point is not transmitting any data). Moreover, wireless clients that use IEEE 802.11k and/or IEEE 802.11v may make roaming decision to perform a BSS or an ESS transition to get better communication performance or service, such as improved throughput.

In the disclosed communication techniques, a hybrid roaming capability in a Wi-Fi network may be facilitated by a cloud-based controller. For example, based on historical data about roaming of a client, the cloud-based controller may send one or more encryption keys and/or may instruct access point to recommend or perform a BSS or an ESS transition. This information may be provided to access points that are not withing wireless range of each other.

Typically, an access point may send the data based at least in part on transmissions and received packets or frames. Moreover, the access point may update airtime based on a client request. However, in the disclosed communication techniques, the cloud-based controller may aggregate historical data about application usage and allocated airtime from one or more access points. Using this historical data, the cloud-based controller may instruct an access point to modify an airtime of a client. Alternatively, or additionally, the cloud-based controller may distribute the historical data to one or more access points, and the one or more access points may use the historical data to determine a modification to the airtime of the client (even if the client does not use the modified airtime until later).

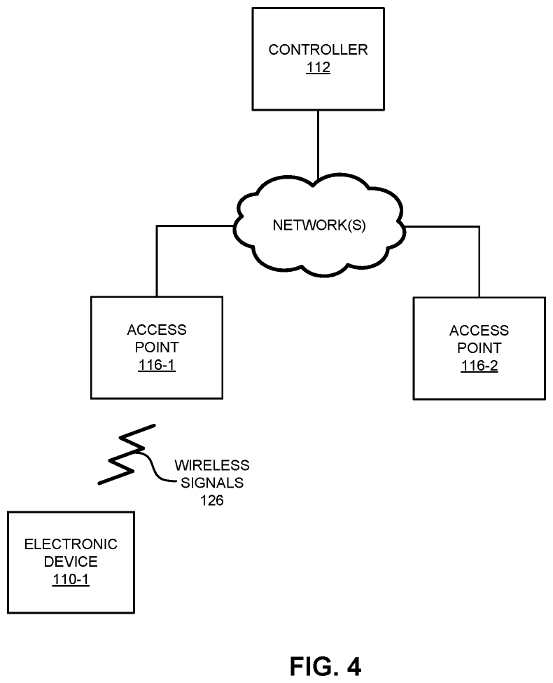

FIG. 4 presents a drawing illustrating an example of predicted future roaming using cloud-based controller 112. Notably, access point 116-1 may send client connection data and/or security keys (such as roaming keys) to cloud-based controller 112. Then, cloud-based controller 112 may dynamically update access-point and client security keys/information for the current connection. Moreover, cloud-based controller 112 may check the client information against previously roamed access points using historical data. Next, cloud-based controller 112 may send information to access point 116-1. Furthermore, access point 116-1 and/or cloud-based controller 112 may disseminate the roaming keys to one or more access points (such as access point 116-2) via a backhaul link.

Note that access point 116-2 may store an encryption or roaming keys that may be received from or may be associated with another access point (such as access point 116-1) that is outside of wireless range of access point 116-1. For example, based on the historical behavior, a cloud-based controller 112 may send the encryption key to access point 116-2. Note that, in general, the encryption key may be sent by the cloud-based controller 112 and/or one or more of access points 116. Moreover, roaming may be initiated by electronic device 110-1 or by one of access points 116 (such as access point 116-1 recommending or performing a BSS or an ESS transition to access point 116-2) in response to an instruction from cloud-based controller 112.

As discussed previously, in other embodiments airtime (and, more generally, wireless resource(s)) allocation may be based at least in part on historical data (such as known client airtime and data patterns). These capabilities may allow for improved channel, radio (such as frequency band) or access-point selection. Moreover, an access point or a cloud-based controller may allocate airtime to clients based at least in part on the type of applications a client uses/invokes and the historical data. The allocation of wireless resources may allow an access point or the cloud-based controller to provide the correct allocation based at least in part on predicted client usage (even when the client has initially connected to an access point with sub-optimal communication performance).

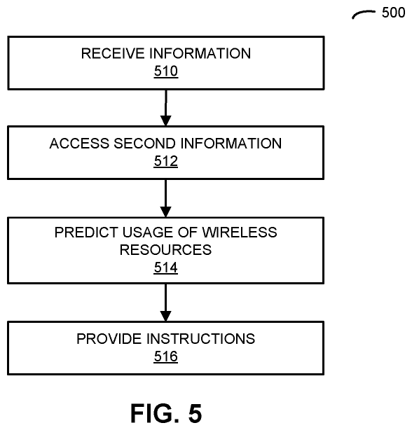

FIG. 5 presents a flow diagram illustrating an example of a method 500 for predicting usage of wireless resources, which may be performed by a computer system (such as computer system 130 in FIG. 1). During operation, the computer system may receive, associated with an access point, information (operation 510) that specifies a request for wireless resources associated with an application executing on an electronic device, where the electronic device is currently associated with the access point. Then, the computer system may access second information (operation 512) specifying historical usage of wireless resources associated with the application. Moreover, based at least in part on the historical usage of the wireless resources, the computer system may predict the usage of the wireless resources (operation 514) associated with the application executing on the electronic device. Next, the computer system may provide, addressed to the access point, instructions (operation 516) for second wireless resources to provide to the electronic device, where the second wireless resources are based at least in part on the predicted usage of the wireless resources, and where the second wireless resources are at least partially different from the wireless resources.

In some embodiments of method 200 (FIG. 2) and/or method 500, there may be additional or fewer operations. Furthermore, the order of the operations may be changed, and/or two or more operations may be combined into a single operation.

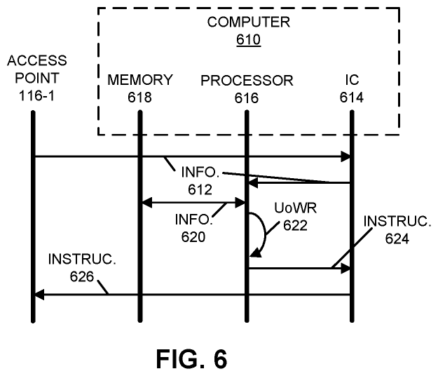

Embodiments of the communication techniques are further illustrated in FIG. 6, which presents a drawing illustrating an example of communication between access point 116-1 and a computer 610 in computer system 130 (FIG. 1). In FIG. 6, access point 116-1 may provide, addressed to computer 610, information 612 that specifies a request for wireless resources associated with an application executing on an electronic device, where the electronic device is currently associated with access point 116-1.

After receiving information 612, an interface circuit 614 in computer 610 may provide information 612 to a processor 616 in computer 610. Then, processor 616 may access, in memory 618 in or associated with computer 610, information 620 specifying historical usage of wireless resources associated with the application. Moreover, based at least in part on the historical usage of the wireless resources, processor 616 may predict the usage of the wireless resources (UoWR) 622 associated with the application executing on the electronic device.

Next, processor 616 may instruct 624 interface circuit 614 to provide, addressed to access point 116-1, instructions 626 for second wireless resources to provide to the electronic device, where the second wireless resources are based at least in part on the predicted usage of the wireless resources 622, and where the second wireless resources are at least partially different from the wireless resources.

While FIGS. 3 and 6 illustrate communication between components using unidirectional or bidirectional communication with lines having single arrows or double arrows, in general the communication in a given operation in this figure may involve unidirectional or bidirectional communication. Moreover, while FIGS. 3 and 6 illustrate operations being performed sequentially or at different times, in other embodiments at least some of these operations may, at least in part, be performed concurrently or in parallel.

FIG. 7 presents a drawing illustrating an example of predicted airtime allocation. Notably, cloud-based controller 112 may dynamically store historical usage data that is received from one or more access points, such as allocation and associated application data. For example, cloud-based controller 112 may update the applications used by the most clients and the associated average airtime used by these applications.

When an electronic device 110-1 associates with access point 116-1, access point 116-1 may report the association (or connection) and an application executing on electronic device 110-1 (such as an application with a priority queue). In response, cloud-based controller 112 may use the historical usage data to determine an allocation of wireless resources from access point 116-1 to electronic device 110-1. In some embodiments, the allocated wireless resources may include access point 116-1 recommending that electronic device 110-1 perform a BSS or an ESS transition to access point 116-1, which may be better able to provide the predicted allocation of wireless resources to electronic device 110-1. Alternatively, or additionally, the wireless resources may include a priority. Thus, a type of access category (e.g., voice, video, etc.) may be assigned to a lower or a higher priority access category based at least in part on the historical usage data, such as data being assigned to a higher priority access category based at least in part on the historical usage data, application tagging and/or dynamic rate control.

Moreover, FIG. 8 presents a drawing illustrating an example of predicted use of wireless resources. Notably, an electronic device 110-1 may connect to a WLAN associated with access point 116-1 that provides airtime based at least in part on an application executing of electronic device 110-1. Then, electronic device 110-1 may invoke an application (e.g., medical software associated with high-definition graphics). Access point 116-1 may evaluate a data packet or frame associated with the application and may decide to consult computer system 130. Moreover, access point 116-1 may request computer system 130 to determine an airtime allocation for the application (and, thus, for electronic device 116-1). In response, computer system 130 may grant 25% more airtime to the application based at least in part on a capability of electronic device 110-1. Next, access point 116-1 may allocate the additional airtime to electronic device 110-1. In some embodiments, access point 116-1 may notify electronic device 110-1 of the additional airtime allocation (e.g., using an inter-access-point protocol via a vendor specific attribute). Note that the additional airtime allocation may be granted to electronic device 110-1 only for use with the application.

We now describe embodiments of an electronic device, which may perform at least some of the operations in the communication techniques. FIG. 9 presents a block diagram illustrating an example of an electronic device 900 in accordance with some embodiments, such as one of: base station 108, one of electronic devices 110, controller 112, one of access points 116, one of radio nodes 118, computer network device 128, or computer system 130. This electronic device includes processing subsystem 910, memory subsystem 912, and networking subsystem 914. Processing subsystem 910 includes one or more devices configured to perform computational operations. For example, processing subsystem 910 can include one or more microprocessors, graphics processing units (GPUs), ASICs, microcontrollers, programmable-logic devices, and/or one or more digital signal processors (DSPs).

Memory subsystem 912 includes one or more devices for storing data and/or instructions for processing subsystem 910 and networking subsystem 914. For example, memory subsystem 912 can include DRAM, static random access memory (SRAM), and/or other types of memory. In some embodiments, instructions for processing subsystem 910 in memory subsystem 912 include: one or more program modules or sets of instructions (such as program instructions 922 or operating system 924, such as Linux, UNIX, Windows Server, or another customized and proprietary operating system), which may be executed by processing subsystem 910. Note that the one or more computer programs, program modules or instructions may constitute a computer-program mechanism. Moreover, instructions in the various modules in memory subsystem 912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 910.

In addition, memory subsystem 912 can include mechanisms for controlling access to the memory. In some embodiments, memory subsystem 912 includes a memory hierarchy that comprises one or more caches coupled to a memory in electronic device 900. In some of these embodiments, one or more of the caches is located in processing subsystem 910.

In some embodiments, memory subsystem 912 is coupled to one or more high-capacity mass-storage devices (not shown). For example, memory subsystem 912 can be coupled to a magnetic or optical drive, a solid-state drive, or another type of mass-storage device. In these embodiments, memory subsystem 912 can be used by electronic device 900 as fast-access storage for often-used data, while the mass-storage device is used to store less frequently used data.

Networking subsystem 914 includes one or more devices configured to couple to and communicate on a wired and/or wireless network (i.e., to perform network operations), including: control logic 916, an interface circuit 918 and one or more antennas 920 (or antenna elements). (While FIG. 9 includes one or more antennas 920, in some embodiments electronic device 900 includes one or more nodes, such as antenna nodes 908, e.g., a metal pad or a connector, which can be coupled to the one or more antennas 920, or nodes 906, which can be coupled to a wired or optical connection or link. Thus, electronic device 900 may or may not include the one or more antennas 920. Note that the one or more nodes 906 and/or antenna nodes 908 may constitute input(s) to and/or output(s) from electronic device 900.) For example, networking subsystem 914 can include a Bluetooth networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 900 may be adapted or changed using pattern shapers (such as directors or reflectors) and/or one or more antennas 920 (or antenna elements), which can be independently and selectively electrically coupled to ground to steer the transmit antenna pattern in different directions. Thus, if one or more antennas 920 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 900 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 900 may use the mechanisms in networking subsystem 914 for performing simple wireless communication between the electronic devices, e.g., transmitting advertising or beacon frames and/or scanning for advertising frames transmitted by other electronic devices as described previously.

Within electronic device 900, processing subsystem 910, memory subsystem 912, and networking subsystem 914 are coupled together using bus 928. Bus 928 may include an electrical, optical, and/or electro-optical connection that the subsystems can use to communicate commands and data among one another. Although only one bus 928 is shown for clarity, different embodiments can include a different number or configuration of electrical, optical, and/or electro-optical connections among the subsystems.

In some embodiments, electronic device 900 includes a display subsystem 926 for displaying information on a display, which may include a display driver and the display, such as a liquid-crystal display, a multi-touch touchscreen, etc.

Moreover, electronic device 900 may include a user-interface subsystem 930, such as: a mouse, a keyboard, a trackpad, a stylus, a voice-recognition interface, and/or another human-machine interface. In some embodiments, user-interface subsystem 930 may include or may interact with a touch-sensitive display in display subsystem 926.

Electronic device 900 can be (or can be included in) any electronic device with at least one network interface. For example, electronic device 900 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 900, in alternative embodiments, different components and/or subsystems may be present in electronic device 900. For example, electronic device 900 may include one or more additional processing subsystems, memory subsystems, networking subsystems, and/or display subsystems. Additionally, one or more of the subsystems may not be present in electronic device 900. Moreover, in some embodiments, electronic device 900 may include one or more additional subsystems that are not shown in FIG. 9. Also, although separate subsystems are shown in FIG. 9, in some embodiments some or all of a given subsystem or component can be integrated into one or more of the other subsystems or component(s) in electronic device 900. For example, in some embodiments instructions 922 is included in operating system 924 and/or control logic 916 is included in interface circuit 918.

Moreover, the circuits and components in electronic device 900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 914 and/or of electronic device 900. The integrated circuit may include hardware and/or software mechanisms that are used for transmitting wireless signals from electronic device 900 and receiving signals at electronic device 900 from other electronic devices. Aside from the mechanisms herein described, radios are generally known in the art and hence are not described in detail. In general, networking subsystem 914 and/or the integrated circuit can include any number of radios. Note that the radios in multiple-radio embodiments function in a similar way to the described single-radio embodiments.

In some embodiments, networking subsystem 914 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 922, operating system 924 (such as a driver for interface circuit 918) or in firmware in interface circuit 918. Alternatively, or additionally, at least some of the operations in the communication techniques may be implemented in a physical layer, such as hardware in interface circuit 918.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an access point and a neighbor access point, wherein the computer system is configured to perform operations comprising:
receiving, associated with the access point, connection information, wherein the connection information indicates that an electronic device is currently associated with the access point in a wireless network;
accessing information specifying historical behavior of the electronic device in the wireless network;
predicting future roaming of the electronic device in the wireless network based at least in part on the historical behavior of the electronic device, wherein the predicted future roaming comprises a prediction that the electronic device will establish a connection with the neighbor access point in the wireless network; and
providing, addressed to the neighbor access point, at least a portion of an encryption key associated with a current connection between the access point and the electronic device.

2. The computer system of claim 1, wherein, when the predicted future roaming occurs, at least the portion of the encryption key facilitates a basic service set (BSS) or an extended service set (ESS) transition is less than a predefined time interval and secure communication with the electronic device.

3. The computer system of claim 1, wherein the predicted future roaming comprises a predicted geographic path of the electronic device, and the neighbor access point is proximate to the predicted geographic path or is within wireless range of the predicted geographic path.

4. The computer system of claim 1, wherein the predicted future roaming is based at least in part on a geographic location of the neighbor access point.

5. The computer system of claim 1, wherein the computer system comprises a controller of the access point and the neighbor access point.

6. The computer system of claim 1, wherein the computer system comprises a cloud-based computer system that communicates with the access point and the neighbor access point using wired communication.

7. The computer system of claim 1, wherein the historical behavior comprises previous geographic locations of the electronic device as a function of timestamp.

8. The computer system of claim 1, wherein the historical behavior comprises previous instances of roaming by the electronic device in the wireless network.

9. The computer system of claim 1, wherein the historical behavior comprises previous throughput or utilization by the electronic device, and the predicted future roaming is based at least in part on current communication performances of the access point and the neighbor access point.

10. A non-transitory computer-readable storage medium for use in conjunction with a computer system, the computer-readable storage medium storing program instructions that, when executed by the computer system, cause the computer system to perform operations comprising:
receiving, associated with an access point, connection information, wherein the connection information indicates that an electronic device is currently associated with the access point in a wireless network;
accessing information specifying historical behavior of the electronic device in the wireless network;
predicting future roaming of the electronic device in the wireless network based at least in part on the historical behavior of the electronic device, wherein the predicted future roaming comprises a prediction that the electronic device will establish a connection with a neighbor access point in the wireless network; and
providing, addressed to the neighbor access point, at least a portion of an encryption key associated with a current connection between the access point and the electronic device.

11. The non-transitory computer-readable storage medium of claim 10, wherein the predicted future roaming comprises a predicted geographic path of the electronic device, and the neighbor access point is proximate to the predicted geographic path or is within wireless range of the predicted geographic path.

12. The non-transitory computer-readable storage medium of claim 10, wherein the predicted future roaming is based at least in part on a geographic location of the neighbor access point.

13. The non-transitory computer-readable storage medium of claim 10, wherein the historical behavior comprises previous geographic locations of the electronic device as a function of timestamp or previous instances of roaming by the electronic device in the wireless network.

14. The non-transitory computer-readable storage medium of claim 10, wherein the historical behavior comprises previous throughput or utilization by the electronic device, and the predicted future roaming is based at least in part on current communication performances of the access point and the neighbor access point.

15. A method for predicting future roaming, comprising:
by a computer system:
receiving, associated with an access point, connection information, wherein the connection information indicates that an electronic device is currently associated with the access point in a wireless network;
accessing information specifying historical behavior of the electronic device in the wireless network;
predicting the future roaming of the electronic device in the wireless network based at least in part on the historical behavior of the electronic device, wherein the predicted future roaming comprises a prediction that the electronic device will establish a connection with a neighbor access point in the wireless network; and
providing, addressed to the neighbor access point, at least a portion of an encryption key associated with a current connection between the access point and the electronic device.

16. The method of claim 15, wherein the predicted future roaming comprises a predicted geographic path of the electronic device, and the neighbor access point is proximate to the predicted geographic path or is within wireless range of the predicted geographic path.

17. The method of claim 15, wherein the predicted future roaming is based at least in part on a geographic location of the neighbor access point.

18. The method of claim 15, wherein the historical behavior comprises previous geographic locations of the electronic device as a function of timestamp

19. The method of claim 15, wherein the historical behavior comprises previous instances of roaming by the electronic device in the wireless network.

20. The method of claim 15, wherein the historical behavior comprises previous throughput or utilization by the electronic device, and the predicted future roaming is based at least in part on current communication performances of the access point and the neighbor access point.
